(19) United States
(12) Patent Application Publication
(10) Pub. No.: US 2026/0321525 A1
(43) Pub. Date: Oct. 15, 2026

(54) INTERLOCK-LINKED SYSTEM FOR INTERLOCKING CIRCUIT BREAKER AND DISCONNECTOR

(71) Applicant: HD HYUNDAI ELECTRIC CO., LTD., Seongnam-si (KR)

(72) Inventors: Min Su LEE, Seoul (KR); Jeong Hong Park, Seoul (KR)

(73) Assignee: HD HYUNDAI ELECTRIC CO., LTD., Seongnam-si (KR)

(21) Appl. No.: 19/639,328

(22) Filed: Apr. 6, 2026

(30) Foreign Application Priority Data
Apr. 9, 2025 (KR) 10-2025-0046285

(51) Int. Cl. H01H 9/26; H01H 3/36; H01H 3/38; H01H 3/46; H01H 19/14; H02B 13/035

(52) U.S. Cl. CPC H01H 9/262; H01H 3/36; H01H 3/38; H01H 3/46; H01H 19/14; H02B 13/035; H01H 2009/265

(57) ABSTRACT

An interlock-linked system for interlocking a circuit breaker and a disconnector. The interlock-linked system includes the circuit breaker including a circuit breaker operation unit capable of being operated. The disconnector is provided as a pair of disconnectors disposed on an upper portion and a lower portion of the circuit breaker. The disconnector includes a disconnector operation unit capable of being operated, and a cable connecting the circuit breaker operation unit and the disconnector operation unit such that the circuit breaker operation unit and the disconnector operation unit are interlocked with each other. The cable is configured to transmit an operational movement of the circuit breaker to the disconnector.

### CROSS REFERENCE TO RELATED APPLICATION

The present application claims priority to Korean Patent Application No. 10-2025-0046285 (filed on Apr. 9, 2025), which is hereby incorporated by reference in its entirety.

### BACKGROUND

The present disclosure relates to an interlock-linked system. More particularly, the present disclosure relates to an interlock-linked system for interlocking a circuit breaker and a disconnector.

Generally, a Gas Insulated Switchgear (GIS) may include a circuit breaker, a disconnector, a potential transformer, a current transformer, and so on.

The circuit breaker includes a function of interrupting a fault current, and the disconnector serves to only disconnect a circuit without performing a load switching function when the circuit breaker interrupts the fault current. Particularly, since a disconnector portion has no current switching capability, an operation of the disconnector portion while a circuit breaker portion is in a conducting state may lead to an accident. In order to prevent accidents caused by such a malfunction, an electrical and mechanical interlock is mounted between the circuit breaker portion and the disconnector.

A conventional mechanical interlock is mounted between an operation unit of the circuit breaker portion and an operation unit of the disconnector.

The mechanical interlock is formed in a rigid body shape, i.e., a bar type, and is configured to lock or unlock a driving unit of the disconnector according to an operating state (On or Off) of the operation unit of the circuit breaker portion.

However, since the mechanical interlock mounted in each operation unit of a conventional gas insulated switchgear is formed in a rigid body shape, there is a problem that damage may occur due to an impact generated during an operation of the circuit breaker. In addition, interference with surrounding components may occur during an operation of the circuit breaker, and a connection of the mechanical interlock to the operation unit is limited. Particular, there is a problem that a movement of a position of the operation unit mounted in the gas insulated switchgear is restricted. Furthermore, since the conventional mechanical interlock increases a weight of the driving unit affecting an operation of the circuit breaker portion, there is a problem that circuit breaking performance is adversely affected.

Related Art: KR 10-0339331 B1

### SUMMARY

Accordingly, the present disclosure has been made keeping in mind the above problems occurring in the related art, and an objective of the present disclosure is to provide an interlock-linked system for interlocking a circuit breaker and a disconnector, the interlock-linked system being capable of preventing an accident caused by a forced operation or a malfunction of the disconnector while the circuit breaker is in a conducting state.

Another objective of the present disclosure is to provide an interlock-linked system for interlocking a circuit breaker and a disconnector, the interlock-linked system using a cable and a wire so as to reduce the overall volume of the interlock, thereby preventing interference with and impact on other components, eliminating restrictions on positional movement of an operation unit, and reducing weight to ensure more efficient performance of an interrupting operation of the circuit breaker.

In order to achieve the objectives described above, according to an aspect of the present disclosure, there is provided an interlock-linked system for interlocking a circuit breaker and a disconnector, the interlock-linked system including: the circuit breaker including a circuit breaker operation unit capable of being operated; the disconnector provided as a pair of disconnectors disposed on an upper portion and a lower portion of the circuit breaker, the disconnector including a disconnector operation unit capable of being operated; and a cable connecting the circuit breaker operation unit and the disconnector operation unit such that the circuit breaker operation unit and the disconnector operation unit are interlocked with each other, the cable being configured to transmit an operational movement of the circuit breaker to the disconnector.

In the interlock-linked system according to an aspect of the present disclosure, the circuit breaker may include: a shaft configured to be rotated according to an intention of a user; and a crank through which the shaft passes and which is interlocked with a movement of the shaft.

In the interlock-linked system according to an aspect of the present disclosure, the disconnector may include: a sprocket provided such that the sprocket is capable of being rotated, the sprocket having a protrusion portion that protrudes from an outer circumferential surface of the sprocket and having a groove portion concave relative to the protrusion portion, and the sprocket having the protrusion portion and the groove portion that are alternately arranged; and a latch connected to the cable and selectively engaged with the sprocket so as to restrict a rotation of the sprocket.

In the interlock-linked system according to an aspect of the present disclosure, the latch may have a first end fixed to a portion of the disconnector such that the latch is capable of being rotated, and may have a second end connected to the cable. Furthermore, the latch may include a protrusion interlocked with an up and down movement of the cable such that the protrusion is selectively inserted into the groove portion of the sprocket.

In the interlock-linked system according to an aspect of the present disclosure, the interlock-linked system may further include a tension spring having a first end connected to a second end portion of the latch and having a second end connected to a portion of the disconnector, the tension spring being configured to apply a tensile force pulling the second end portion of the latch such that the protrusion is inserted into the groove portion of the sprocket when the second end portion of the latch is lifted upward.

In the interlock-linked system according to an aspect of the present disclosure, the cable may have a hollow flexible tubular shape, and the interlock-linked system may further include a wire inserted into a hollow inner portion of the cable and connected to the circuit breaker and the disconnector.

In the interlock-linked system according to an aspect of the present disclosure, the crank may have a pair of parallel crank grooves formed in an outer circumferential surface of the crank, and each wire of a corresponding one of a pair of cables respectively connected to the pair of disconnectors may be at least partially inserted into each of the pair of crank grooves.

In the interlock-linked system according to an aspect of the present disclosure, the interlock-linked system may further include: an enlarged head formed at an end of the wire, the enlarged head having a thickness larger than a width of each of the pair of crank grooves; and a pin which is provided such that the pin across the crank grooves and on which the enlarged head is caught such that the wire is wound or unwound on the crank according to a rotation of the crank.

The present disclosure is capable of preventing accidents caused by a forced operation or a malfunction of the disconnector while the circuit breaker is in a conducting state. Furthermore, by using the cable and the wire, the present disclosure is capable of achieving reducing the volume of the interlock to prevent interference with and impact on other components, eliminating restrictions on positional movement of the operation unit, and reducing weight, so that more efficient performance of the interrupting operation of the circuit breaker may be secured.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a front view illustrating a circuit breaker and a disconnector of an interlock-linked system for interlocking the circuit breaker and the disconnector according to an embodiment of the present disclosure;

FIG. 2 is a projection view schematically illustrating an inner portion of components in FIG. 1;

FIG. 3 is a partially enlarged view illustrating a part of an inner portion of the circuit breaker in FIG. 1;

FIG. 4 is a perspective view schematically illustrating an inner portion of the disconnector in FIG. 1;

FIG. 5A is a view illustrating a state in which a latch and a sprocket are spaced apart from each other in FIG. 4;

FIG. 5B is a view illustrating a state in which a part of the latch is fitted to the sprocket in FIG. 4;

FIG. 6 is a view illustrating a cable and a wire of the interlock-linked system for interlocking the circuit breaker and the disconnector according to an embodiment of the present disclosure; and

FIG. 7 is an enlarged view illustrating a shaft and a crank in FIG. 3.

### DETAILED DESCRIPTION

Hereinafter, embodiments of the present disclosure will be described in detail through exemplary drawings. In adding reference numerals to components throughout the drawings, it is to be noted that like or similar reference numerals designate like or similar components even though the components are illustrated in different drawings. In addition, in describing embodiments of the present disclosure, when it is determined that a detailed description of a related known configuration or function may obscure the gist of the present disclosure, the detailed description thereof will be omitted.

In addition, in describing the components of embodiments of the present disclosure, terms such as first, second, A, B, (a), (b), and so on may be used. These terms are only for distinguishing the component from other components, and are not limited to the essence, order, or sequence of the component by the terms. When a component is described as being “connected”, “coupled”, or “linked” to another component, the component may be directly connected or linked to the other component, or other components may be “connected”, “coupled” or “linked” to therebetween.

Hereinafter, an interlock-linked system for interlocking a circuit breaker and a disconnector according to an embodiment of the present disclosure will be described with reference to the accompanying drawings.

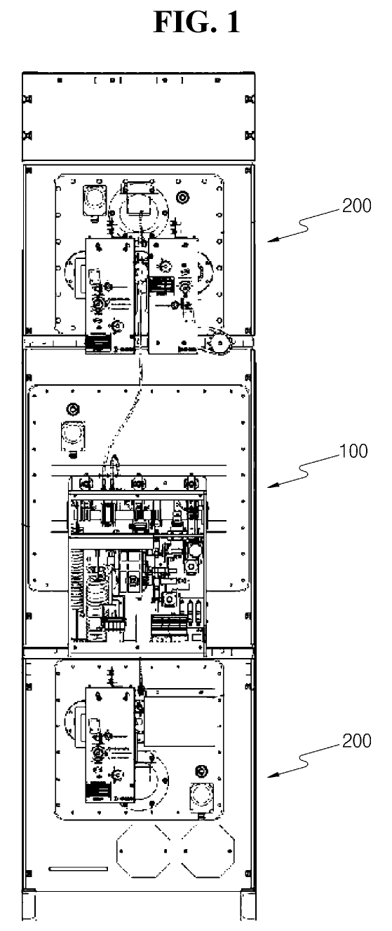

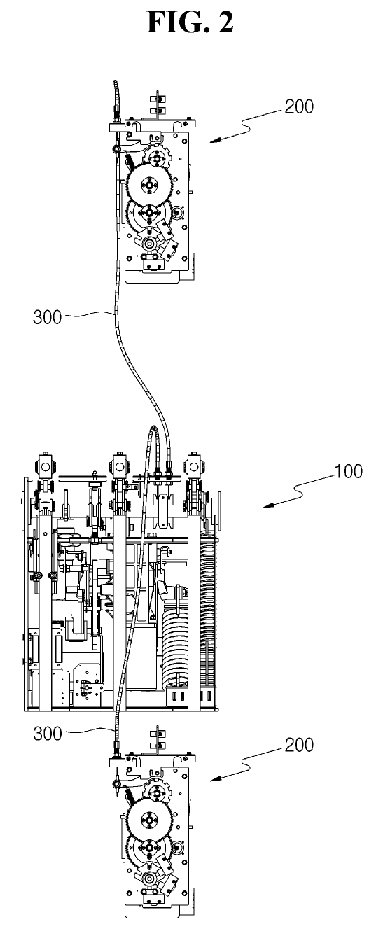

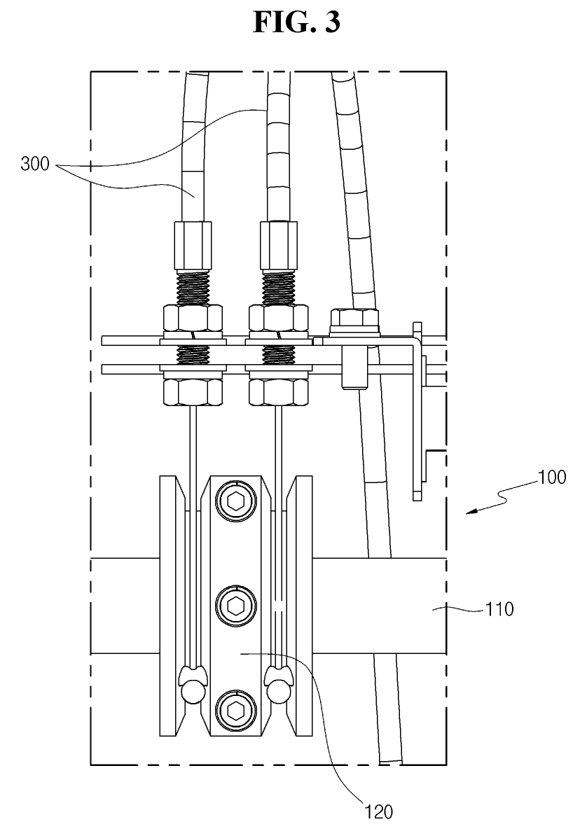

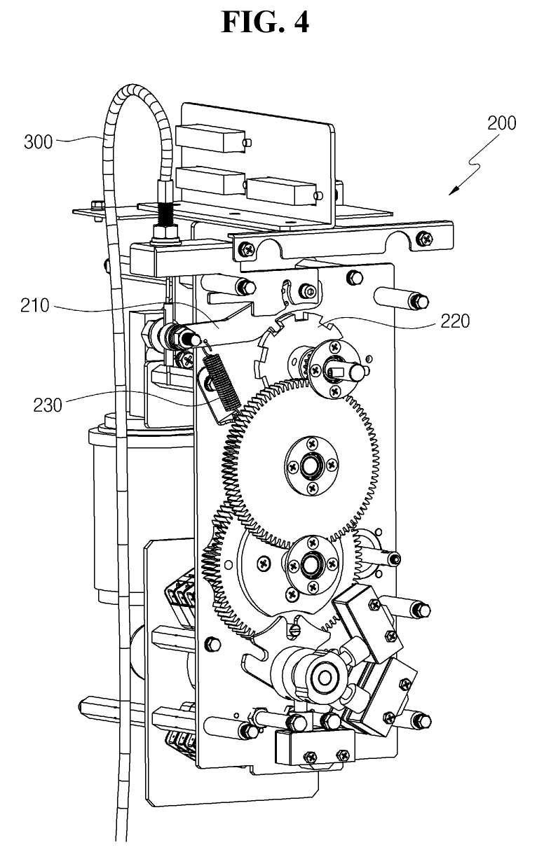

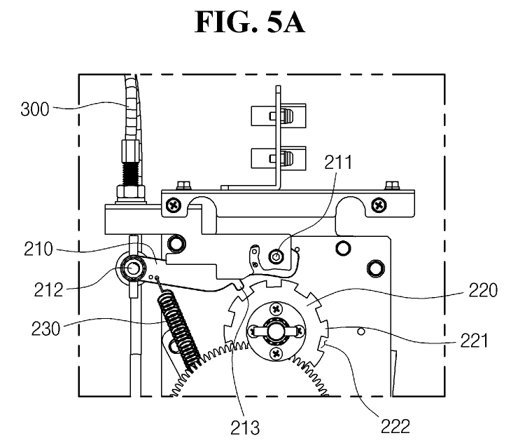

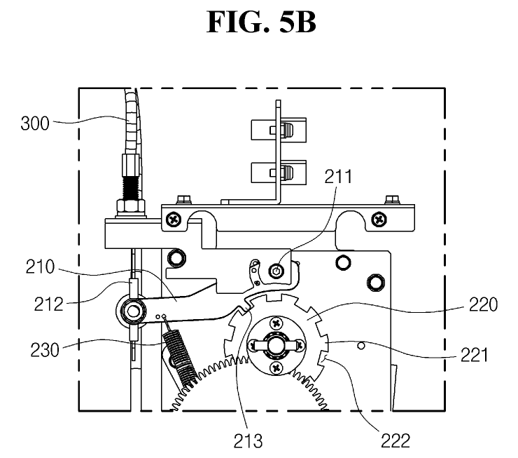

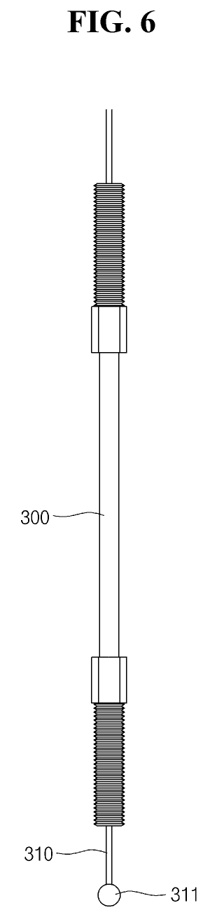

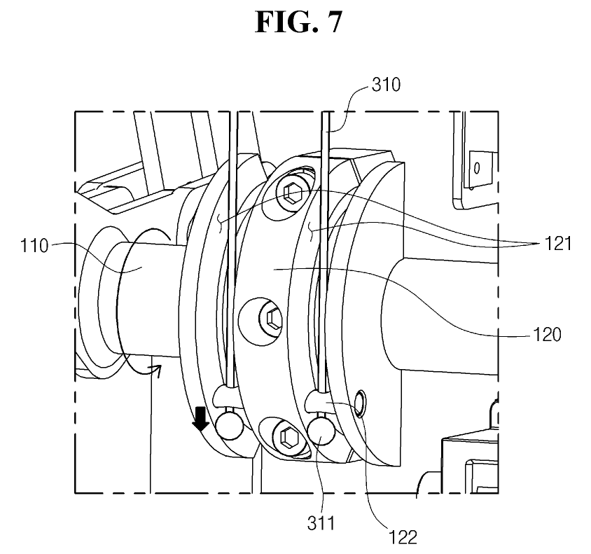

FIG. 1 is a front view illustrating a circuit breaker and a disconnector of an interlock-linked system for interlocking the circuit breaker and the disconnector according to an embodiment of the present disclosure, FIG. 2 is a projection view schematically illustrating an inner portion of components in FIG. 1, FIG. 3 is a partially enlarged view illustrating a part of an inner portion of the circuit breaker in FIG. 1, FIG. 4 is a perspective view schematically illustrating an inner portion of the disconnector in FIG. 1, FIG. 5A is a view illustrating a state in which a latch and a sprocket are spaced apart from each other in FIG. 4, FIG. 5B is a view illustrating a state in which a part of the latch is fitted to the sprocket in FIG. 4, FIG. 6 is a view illustrating a cable and a wire of the interlock-linked system for interlocking the circuit breaker and the disconnector according to an embodiment of the present disclosure, and FIG. 7 is an enlarged view illustrating a shaft and a crank in FIG. 3.

Referring to FIG. 1, an interlock-linked system for interlocking a circuit breaker and a disconnector according to an embodiment of the present disclosure may include a circuit breaker 100 including a circuit breaker operation unit (not shown) capable of being operated by a user, and may include a pair of disconnectors 200 disposed at upper and lower portions of the circuit breaker 100 and interlocked with the circuit breaker 100, the pair of disconnectors 200 each including a disconnector operation unit (not shown) capable of being operated by the user.

Referring to FIG. 2, a cable 300 may be connected between the circuit breaker 100 and the disconnector 200. That is, the cable 300 may connect the circuit breaker operation unit and the disconnector operation unit so as to be interlocked with each other, and may transmit an operational movement of the circuit breaker 100 to the disconnector 200.

Referring to FIG. 3, the circuit breaker 100 may include a shaft 110 and a crank 120.

The shaft 110 is capable of being rotated according to an intention of the user. That is, the user may forcibly rotate the shaft 110 through the circuit breaker operation unit.

The crank 120 may have a substantially cylindrical shape, the shaft 110 may pass through or may be connected to the crank 120, and the crank 120 may be interlocked with a movement of the shaft 110. A pair of concave crank grooves 121 may be formed in parallel along an outer circumferential surface of the crank 120. Each wire 310 of the cable 300, which will be described later, may be inserted into each of the crank grooves 121. In addition, among the wires 310 respectively inserted into the pair of crank grooves 121, one wire 310 may be connected to the disconnector 200 disposed at the upper portion of the circuit breaker 100, and the other wire 310 may be connected to the disconnector 200 disposed at the lower portion of the circuit breaker 100.

The crank 120 may further include a pin 122, and the pin 122 will be described together with the wire 310 later.

Referring to FIGS. 4 and 5, the disconnector 200 may include a sprocket 220 and a latch 210.

The latch 210 may have a first end portion connected to a portion of the disconnector 200 such that the latch 210 is capable of being rotated. In addition, the latch 210 may have a second end portion connected to the cable 300, and the second end portion of the latch 210 is capable of being moved upward or downward according to an operation of the cable 300. By such an operation, as illustrated in FIGS. 5A or 5B, a protrusion 213 of the latch 210 may be selectively engaged with the sprocket 220 that will be described later, thereby being capable of restricting a rotation of the sprocket 220.

The sprocket 220 may be provided in the disconnector 200 such that the sprocket 220 is capable of being rotated. The sprocket 220 may include a protrusion portion 221 that protrudes from an outer circumferential surface of the sprocket 220, and may include a groove portion 222 that is concave relative to the protrusion portion 221. Here, the protrusion portion 221 and the groove portion 222 may be alternately arranged. The sprocket 220 may determine a disconnecting operation of the disconnector 200 by being rotated. Here, when the protrusion 213 of the latch 210 is inserted into the groove portion 222 of the sprocket 220, the rotation of the sprocket 220 may be restricted.

A tension spring 230 may have a first end connected to the second end of the latch 210, and may have a second end connected to a portion of the disconnector 200. The tension spring 230 may be stretched and may generate a tensile force when the second end of the latch 210 is lifted upward. The tension spring 230 may pull the second end of the latch 210 such that the protrusion 213 is inserted into the groove portion 222 of the sprocket 220 by the tensile force. That is, when the user operates the circuit breaker 100 or when a mechanical or structural problem occurs, the tension spring 230 may induce engagement between the latch 210 and the sprocket 220 so as to prevent the rotation of the sprocket 220.

The cable 300 may have a hollow flexible tubular shape, and the wire 310 may be accommodated in a hollow interior of the cable 300.

The wire 310 may be inserted into the hollow interior of the cable 300, and both ends of the wire 310 may be respectively connected to the circuit breaker 100 and the disconnector 200. In addition, although the cable 300 has been described as being operated for convenience of explanation in the above description, it should be understood that the wire 310 is actually operated. A pair of cables 300 may be provided, and a pair of wires 310 may also be provided. Furthermore, each of the pair of wires 310 may have at least a portion inserted into a corresponding one of the pair of crank grooves 121. Accordingly, the user may operate the pair of disconnectors 200 disposed at the upper and lower portions of the circuit breaker 100 at once by operating the circuit breaker 100 once.

A first side of the wire 310 may be connected to the crank 120 of the circuit breaker 100, and a second side of the wire 310 may be connected to the latch 210 of the disconnector 200. As described above, a first end of the wire 310 may be inserted into the crank groove 121.

An enlarged head 311 may be provided at the first end of the wire 310. The enlarged head 311 may have a thickness larger than a width of the crank groove 121. Due to the thickness of the enlarged head 311, the enlarged head 311 may not be inserted into the crank groove 121. Meanwhile, the crank 120 is provided with the pin 122 disposed across the crank groove 121, and the enlarged head 311 may be caught by the pin 122. That is, even when the user operates the circuit breaker 100 so that the shaft 110 and the crank 120 are rotated and the wire 310 is loosened, the wire 310 may be prevented from being completely separated from the crank groove 121 by the enlarged head 311. Conversely, when the user operates the circuit breaker 100, the enlarged head 311 is caught by the pin 122, so that the shaft 110 and the crank 120 may be rotated and the wire 310 may be at least partially wound around the crank 120.

The description above is about the embodiments for implementing the interlock-linked system for interlocking the circuit breaker and the disconnector according to the present disclosure, and the present disclosure is not limited to the above-described embodiments, and those skilled in the art to which the present disclosure belongs may variously modify the embodiments without departing the gist of the present disclosure claimed in the scope of the following claims.

1. An interlock-linked system for interlocking a circuit breaker and a disconnector, the interlock-linked system comprising: the circuit breaker comprising a circuit breaker operation unit capable of being operated;
the disconnector provided as a pair of disconnectors disposed on an upper portion and a lower portion of the circuit breaker, the disconnector comprising a disconnector operation unit capable of being operated; and
a cable connecting the circuit breaker operation unit and the disconnector operation unit such that the circuit breaker operation unit and the disconnector operation unit are interlocked with each other, the cable being configured to transmit an operational movement of the circuit breaker to the disconnector.

2. The interlock-linked system of claim 1, wherein the circuit breaker comprises:
a shaft configured to be rotated according to an intention of a user; and
a crank through which the shaft passes and which is interlocked with a movement of the shaft.

3. The interlock-linked system of claim 1, wherein the disconnector comprises:
a sprocket provided such that the sprocket is capable of being rotated, the sprocket having a protrusion portion that protrudes from an outer circumferential surface of the sprocket and having a groove portion concave relative to the protrusion portion, and the sprocket having the protrusion portion and the groove portion that are alternately arranged; and
a latch connected to the cable and selectively engaged with the sprocket so as to restrict a rotation of the sprocket.

4. The interlock-linked system of claim 3, wherein the latch has a first end fixed to a portion of the disconnector such that the latch is capable of being rotated, and has a second end connected to the cable, and
wherein the latch comprises a protrusion interlocked with an up and down movement of the cable such that the protrusion is selectively inserted into the groove portion of the sprocket.

5. The interlock-linked system of claim 4, further comprising:
a tension spring having a first end connected to a second end portion of the latch and having a second end connected to a portion of the disconnector, the tension spring being configured to apply a tensile force pulling the second end portion of the latch such that the protrusion is inserted into the groove portion of the sprocket when the second end portion of the latch is lifted upward.

6. The interlock-linked system of claim 2, wherein the cable has a hollow flexible tubular shape, and
wherein the interlock-linked system further comprises a wire inserted into a hollow inner portion of the cable and connected to the circuit breaker and the disconnector.

7. The interlock-linked system of claim 6, wherein the crank has a pair of parallel crank grooves formed in an outer circumferential surface of the crank, and
wherein each wire of a corresponding one of a pair of cables respectively connected to the pair of disconnectors is at least partially inserted into each of the pair of crank grooves.

8. The interlock-linked system of claim 7, further comprising:
an enlarged head formed at an end of the wire, the enlarged head having a thickness larger than a width of each of the pair of crank grooves; and
a pin which is provided such that the pin across the crank grooves and on which the enlarged head is caught such that the wire is wound or unwound on the crank according to a rotation of the crank.
